(19) United States
(12) Patent Application Publication
(10) Pub. No.: US 2015/0369682 A1
(43) Pub. Date: Dec. 24, 2015

(54) Physical Quantity Sensor Apparatus, Altimeter, Electronic Apparatus, And Moving Object

(71) Applicant: Seiko Epson Corporation, Tokyo (JP)

(72) Inventor: Satoshi Nakajima, Okaya-shi (JP)

(21) Appl. No.: 14/734,728

(22) Filed: Jun. 9, 2015

(30) Foreign Application Priority Data
Jun. 18, 2014 (JP) 2014-125089

(51) Int. Cl. G01L 9/06; G01C 5/06

(52) U.S. Cl. CPC G01L 9/065; G01C 5/06

(57) ABSTRACT

A physical quantity sensor apparatus includes a physical quantity sensor including a flexurally deformable diaphragm including a pressure receiving surface and a temperature sensor disposed on the pressure receiving surface side of the diaphragm to be spaced apart from the diaphragm. The pressure sensor includes a hollow section, which is a pressure reference chamber, on a surface side opposite to the pressure receiving surface of the diaphragm.

### CROSS REFERENCE

This application claims benefit of Japanese Application No. 2014-125089, filed on Jun. 18, 2014. The disclosure of the prior application is hereby incorporated by reference herein in its entirety.

### BACKGROUND

1. Technical Field

The present invention relates to a physical quantity sensor apparatus, an altimeter, an electronic apparatus, and a moving object.

2. Related Art

For example, a pressure sensor module described in JP-A-2013-164332 (Patent Literature 1) includes a pressure sensor apparatus including a diaphragm section and configured to detect pressure on the basis of deflection of the diaphragm section and a temperature compensating apparatus including a temperature measuring section (a temperature sensor section). The pressure sensor section and the temperature measuring section are thermally connected via a heat transfer wire. Therefore, it is possible to perform temperature compensation for the detected pressure on the basis of the temperature of the pressure sensor section measured by the temperature measuring section.

However, in the pressure sensor module having such a configuration, since the pressure sensor apparatus and the temperature compensating apparatus are disposed side by side, the clearance between the pressure sensor apparatus (in particular, the diaphragm section) and the temperature measuring section increases. Therefore, the temperature measuring section cannot accurately perform temperature measurement of the pressure sensor apparatus (in particular, the diaphragm section). Therefore, highly accurate temperature compensation cannot be performed.

### SUMMARY

An advantage of some aspects of the invention is to provide a physical quantity sensor apparatus, an altimeter, an electronic apparatus, and a moving object that can perform excellent temperature compensation.

The invention can be implemented as the following application examples.

### Application Example 1

This application example is directed to a physical quantity sensor apparatus including: a physical quantity sensor including a flexurally deformable diaphragm including a pressure receiving surface; and a temperature sensor element disposed on the pressure receiving surface side of the diaphragm to be spaced apart from the diaphragm.

With this configuration, it is possible to obtain the physical quantity sensor apparatus that can perform excellent temperature compensation.

### Application Example 2

In the physical quantity sensor apparatus according to this application example, it is preferable that the temperature sensor element at least partially overlaps the diaphragm in plan view of the pressure receiving surface.

With this configuration, it is possible to further reduce the distance between the diaphragm and the temperature sensor element. It is possible to more accurately detect the temperature of a pressure sensor (in particular, the temperature of the diaphragm) with a temperature sensor.

### Application Example 3

In the physical quantity sensor apparatus according to this application example, it is preferable that the physical quantity sensor includes a pressure reference chamber on a surface side opposite to the pressure receiving surface of the diaphragm.

With this configuration, it is possible to accurately detect a received physical quantity (in particular, pressure).

### Application Example 4

In the physical quantity sensor apparatus according to this application example, it is preferable that the physical quantity sensor includes a signal output section configured to output a signal corresponding to deflection of the diaphragm.

With this configuration, it is possible to extract a received physical quantity as a signal.

### Application Example 5

In the physical quantity sensor apparatus according to this application example, it is preferable that the signal output section includes a piezo-resistance element disposed in the diaphragm.

With this configuration, the configuration of the signal output section is simplified.

### Application Example 6

In the physical quantity sensor apparatus according to this application example, it is preferable that the physical quantity sensor apparatus includes resin disposed between the diaphragm and the temperature sensor element.

With this configuration, it is possible to protect the diaphragm.

### Application Example 7

In the physical quantity sensor apparatus according to this application example, it is preferable that the resin is gel-like or liquid-like.

With this configuration, it is possible to efficiently transmit a received physical quantity to the diaphragm.

### Application Example 8

This application example is directed to an altimeter including the physical quantity sensor apparatus according to the application example described above.

With this configuration, it is possible to obtain the altimeter having high reliability.

### Application Example 9

This application example is directed to an electronic apparatus including the physical quantity sensor apparatus according to the application example described above.

With this configuration, it is possible to obtain the electronic apparatus having high reliability.

### Application Example 10

This application example is directed to a moving object including the physical quantity sensor apparatus according to the application example described above.

With this configuration, it is possible to obtain the moving object having high reliability.

### BRIEF DESCRIPTION OF THE DRAWINGS

The invention will be described with reference to the accompanying drawings, wherein like numbers reference like elements.

FIG. 1 is a sectional view showing a physical quantity sensor apparatus according to a first embodiment of the invention.

FIG. 2 is a plan view of the physical quantity sensor apparatus shown in FIG. 1.

FIG. 3 is a sectional view showing a physical quantity sensor included in the physical quantity sensor apparatus.

FIG. 4 is a plan view showing a pressure sensor section included in the physical quantity sensor shown in FIG. 3.

FIG. 5 is a diagram showing a circuit including the pressure sensor section shown in FIG. 4.

FIG. 6 is a plan view showing a physical quantity sensor apparatus according to a second embodiment of the invention.

FIG. 7 is a perspective view showing an example of an altimeter according to the invention.

FIG. 8 is a front view showing an example of an electronic apparatus according to the invention.

FIG. 9 is a perspective view showing an example of a moving object according to the invention.

### DESCRIPTION OF EXEMPLARY EMBODIMENTS

Preferred embodiments of the invention are explained in detail below with reference to the drawings.

### First Embodiment

### 1. Physical Quantity Sensor Apparatus

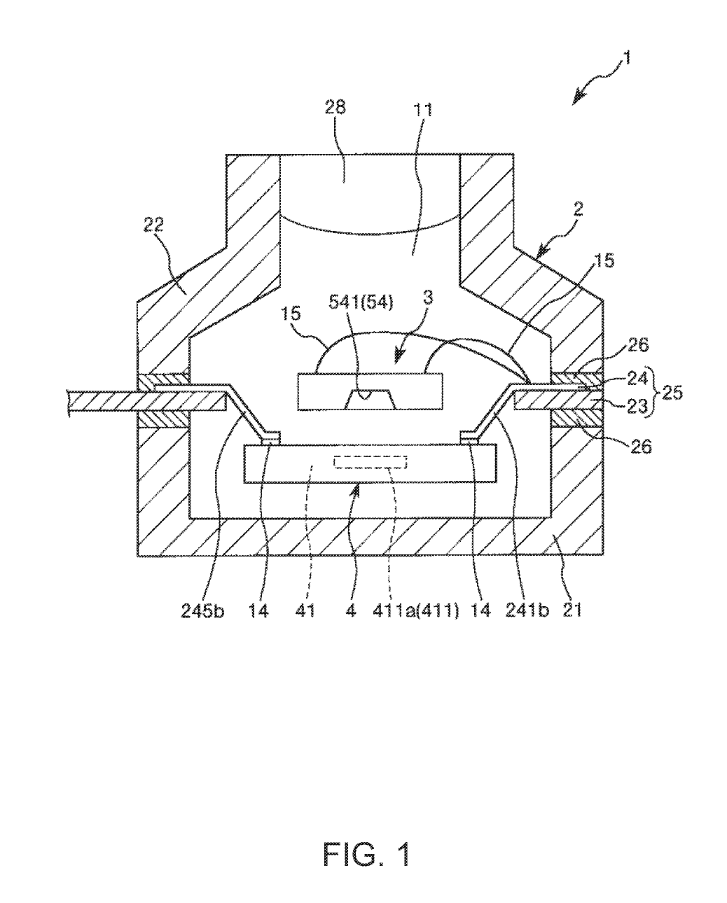

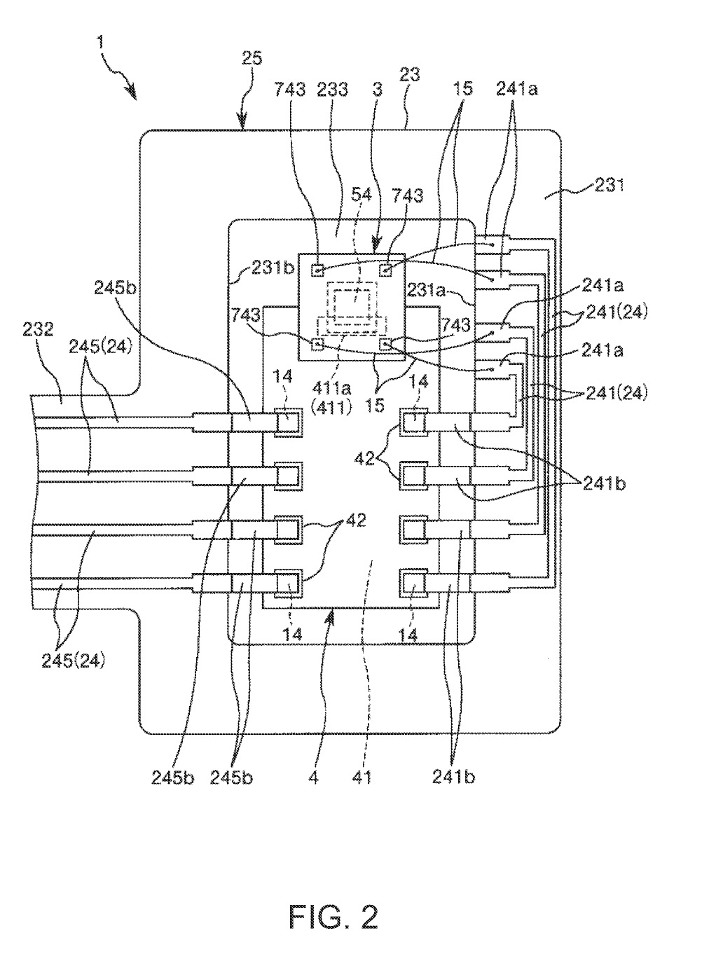

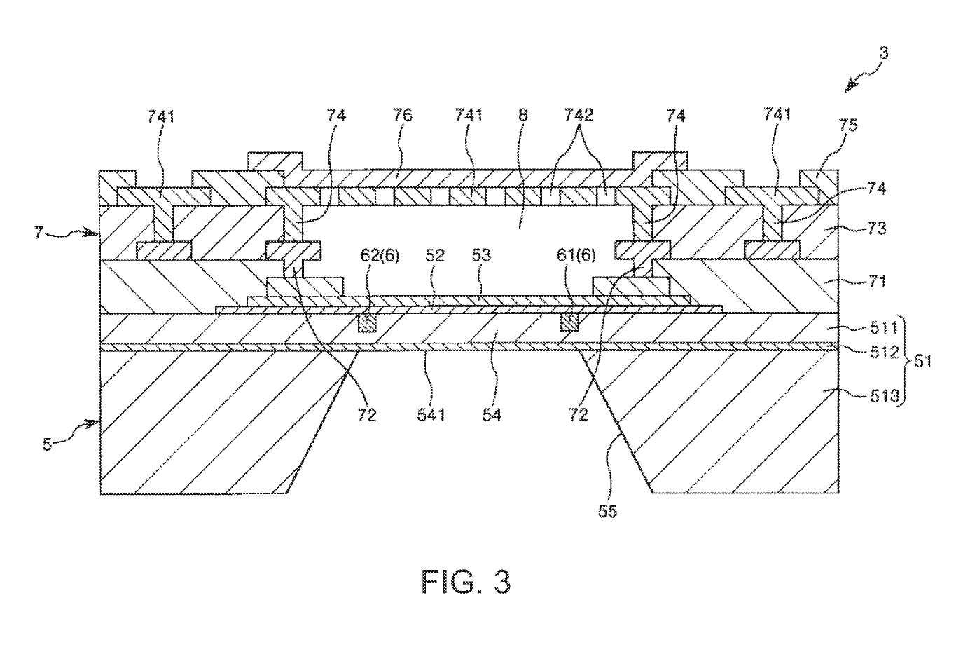

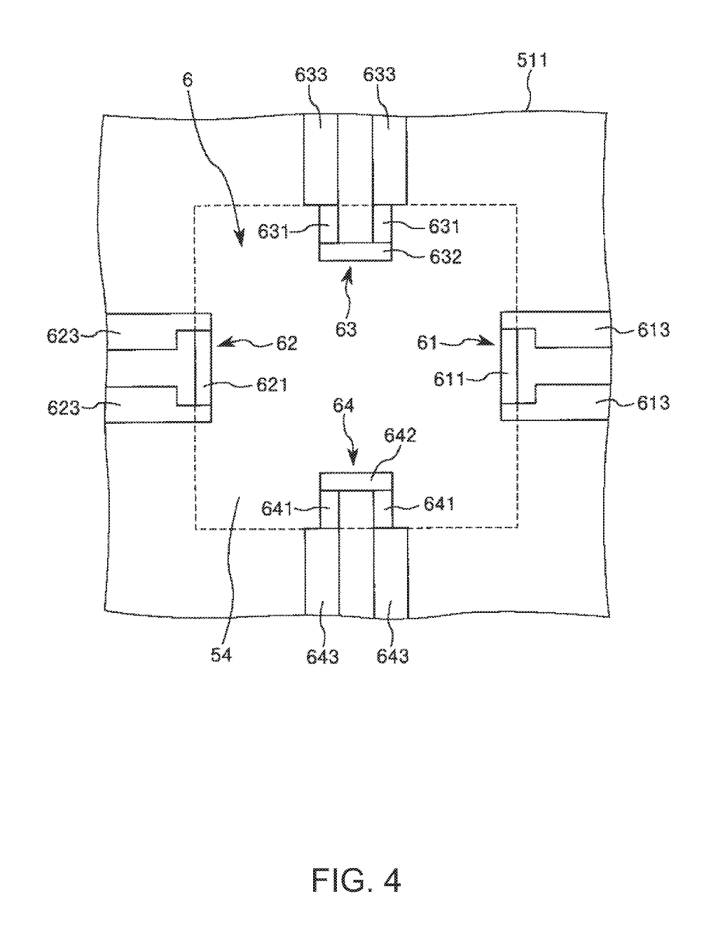

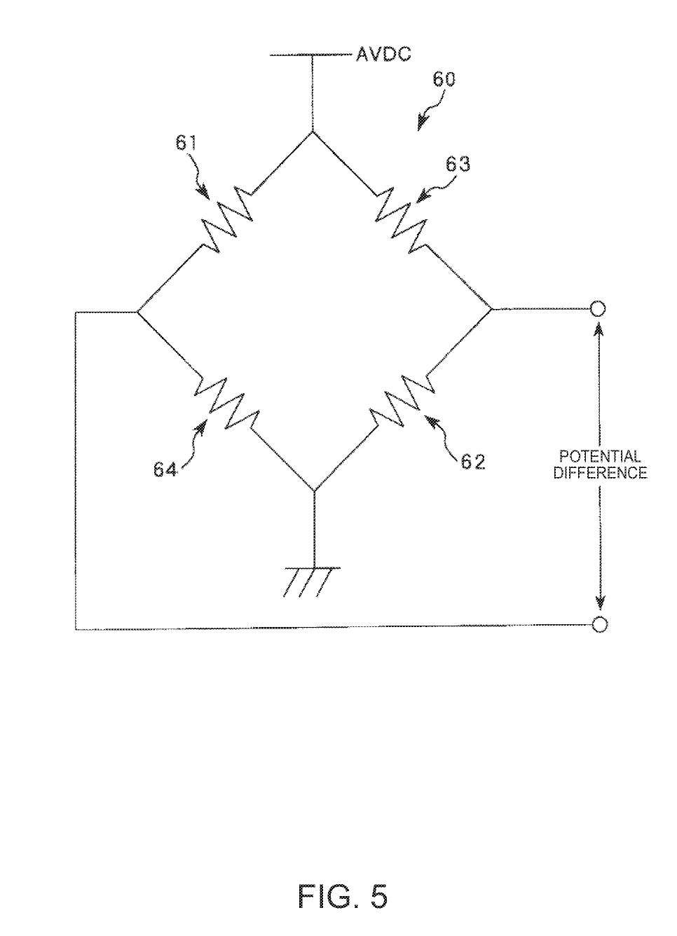

FIG. 1 is a sectional view showing a physical quantity sensor apparatus according to a first embodiment of the invention. FIG. 2 is a plan view of the physical quantity sensor apparatus shown in FIG. 1. FIG. 3 is a sectional view showing a physical quantity sensor included in the physical quantity sensor apparatus. FIG. 4 is a plan view showing a pressure sensor section included in the physical quantity sensor shown in FIG. 3. FIG. 5 is a diagram showing a circuit including the pressure sensor section shown in FIG. 4. Note that, in the following explanation, the upper side in FIGS. 1 and 3 is referred to as “upper” and the lower side in FIGS. 1 and 3 is referred to as “lower”.

A pressure sensor apparatus (a physical quantity sensor apparatus) 1 shown in FIG. 1 includes a pressure sensor (a physical quantity sensor) 3, an IC chip 4 electrically connected to the pressure sensor 3 and including a temperature sensor 411, a package 2 that houses the pressure sensor 3 and the IC chip 4, and a filling material 11 that surrounds the pressure sensor 3 and the IC chip 4 in the package 2. These sections are explained in order below.

### Package

The package 2 has a function of housing the pressure sensor 3 in an internal space 28 formed on the inside of the package 2 and fixing the pressure sensor 3.

As shown in FIG. 1, the package 2 includes a base 21, a housing 22, and a flexible wiring board 25. The base 21 and the housing 22 are jointed to the flexible wiring board 25 to sandwich the flexible wiring board 25. The joining of the base 21 and the flexible wiring board 25 and the joining of the housing 22 and the flexible wiring board 25 are respectively performed via adhesive layers 26 formed by adhesives.

The base 21 configures the bottom surface of the package 2. In this embodiment, the entire shape of the base 21 is a planar shape. The plan view shape of the base 21 is a square shape. A material forming the base 21 is not particularly limited. However, examples of the material include insulating materials such as various ceramics including ceramic oxides such as alumina, silica, titania, and zirconia and ceramic nitrides such as silicon nitride, aluminum nitride, and titanium nitride and various resin materials including polyethylene, polyamide, polyimide, polycarbonate, acrylic resin, ABS resin, and epoxy resin. Among these materials, one kind can be used or two or more kinds can be used in combination. Among these materials, the material is preferably the various ceramics. Consequently, it is possible to obtain the package 2 having excellent mechanical strength. Note that, besides, the plan view shape of the base 21 may be, for example, a circular shape or a polygonal shape such as a rectangular shape or a pentagonal shape.

The housing 22 configures a lid section of the package 2. In this embodiment, the entire shape of the housing 22 is a cylindrical shape. The housing 22 includes a first part where the outer diameter and the inner diameter of the housing 22 gradually decrease from the lower end toward the upper end up to a halfway part in the package height and a second part where the outer diameter and the inner diameter are substantially fixed from the halfway part toward the upper end. As a material forming the housing 22, materials same as the examples of the materials forming the base 21 can be used. Note that the shape of the housing 22 is not particularly limited.

The flexible wiring board 25 is located between the base 21 and the housing 22 in the thickness direction of the package 2 and has a function of supporting the pressure sensor 3 and the IC chip 4 in the package 2 and extracting electric signals received from the pressure sensor 3 and the IC chip 4 to the outside of the package 2. The flexible wiring board 25 is configured by a substrate 23 having flexibility and a wire 24 formed on the upper surface side of the substrate 23.

As shown in FIG. 2, the substrate 23 is configured by a frame section 231 formed in a substantially square frame shape and including an opening 233 in the center and a belt body 232 formed in a belt shape and integrally formed to project on one side of the frame section 231. A material forming the substrate 23 is not particularly limited as long as the material has flexibility. Examples of the material include polyimide, polyethylene terephthalate (PET), polyethylene naphthalate (PEN), and polyether sulfone (PES). Among these materials, one kind can be used or two or more kinds can be used in combination.

The wire 24 has electric conductivity and is provided (drawn around) from the frame section 231 to the belt body 232. The wire 24 includes four wiring sections 241 that support (suspend) the pressure sensor 3 and electrically connect the pressure sensor 3 and the IC chip 4 and four wiring sections 245 that support the IC chip 4 and are electrically connected to the IC chip 4.

End portions on the pressure sensor 3 side of the four wiring sections 241 are respectively formed as terminals 241a. End portions on the IC chip 4 side of the four wiring sections 241 are respectively formed as flying leads 241b. The four terminals 241a are disposed side by side along one side 231a of the frame section 231. The four flying leads 241b are disposed side by side along the same side 231a. By disposing the terminals 241a and the flying leads 241b side by side along the same side 231a in this way, it is possible to reduce the length of the wiring sections 241 and reduce occurrence of noise.

The four terminals 241a are electrically connected to the pressure sensor 3 respectively via bonding wires (metal wires) 15. The pressure sensor 3 is separated from the frame section 231 and supported by the bonding wires 15. On the other hand, the four flying leads 241b are respectively provided such that the distal end sides thereof project into the opening 233. At the distal end portions, the flying leads 241b are electrically connected to the IC chip 4 via conductive fixing members 14. The IC chip 4 is separated from the frame section 231 and supported by the flying leads 241b. With the configuration explained above, the pressure sensor 3 and the IC chip 4 are electrically connected via the four wiring sections 241.

On the other hand, the proximal end sides of the four wiring sections 245 are provided in the belt body 232 and the distal end sides of the four wiring sections 245 are provided in the frame section 231. The distal end portions of the four wiring sections 245 are disposed along a side 231b opposed to the side 231a and formed as flying leads 245b. The four flying leads 245b are respectively provided such that the distal end sides thereof project into the opening 233. At the distal end portions, the flying leads 245b are electrically connected to the IC chip 4 via the fixing members 14. The IC chip 4 is separated from the frame section 231 and supported by the flying leads 245b.

With the package 2 having such a configuration, by electrically connecting, for example, a motherboard of an electronic apparatus or a moving object explained below to the end portions of the wiring sections 245, it is possible to extract electric signals received from the pressure sensor 3 and the IC chip 4 to the outside of the package 2.

Note that the number of wiring sections included in the wire 24 is not particularly limited and only has to be set as appropriate according to the number of connection terminals 743 provided in the pressure sensor 3 and the number of connection terminals 42 provided in the IC chip 4. A material forming the wire 24 is not particularly limited as long as the material has electric conductivity. Examples of the material include metal such as Ni, Pt, Li, Mg, Sr, Ag, Cu, Co, and Al, alloys such as MgAg, AlLi, and CuLi containing these kinds of metal, and oxides such as ITO and SnO₂. Among these materials, one kind can be used or two or more kinds can be used in combination.

### Pressure Sensor

As shown in FIG. 3, the pressure sensor 3 includes a substrate 5, a pressure sensor section 6, an element peripheral structure 7, a hollow section 8, and a not-shown semiconductor circuit. These sections are explained in order below.

The substrate 5 is formed in a tabular shape and configured by stacking, on a semiconductor substrate 51 configured by an SOI substrate (a substrate in which a first Si layer 511, an SiO₂ layer 512, and a second Si layer 513 are stacked in this order), a first insulating film 52 configured by a silicon oxide film (SiO₂ film) and a second insulating film 53 configured by a silicon nitride film (SiN film) in this order. However, the semiconductor substrate 51 is not limited to the SOI substrate. For example, the silicon substrate can be used.

In the semiconductor substrate 51, a diaphragm 54 thinner than a peripheral portion and flexurally deformed by received pressure is provided. The diaphragm 54 is formed by providing a bottomed recess 55 on the lower surface of the semiconductor substrate 51. The lower surface of the diaphragm 54 (the bottom surface of the recess 55) is formed as a pressure receiving surface 541.

A not-shown semiconductor circuit (a circuit) is fabricated on the semiconductor substrate 51 and above the semiconductor substrate 51. The semiconductor circuit includes an active element such as a MOS transistor and circuit elements such as a capacitor, an inductor, a resistor, a diode, and a wire according to necessity.

The pressure sensor section (an output signal section) 6 includes, as shown in FIG. 4, four piezo-resistance elements 61, 62, 63, and 64 provided in the diaphragm 54. The four piezo-resistance elements 61, 62, 63, and 64 are respectively provided to correspond to the sides of the diaphragm 54 formed in a square shape in plan view.

The piezo-resistance elements 61 and 62 include piezo-resistance sections 611 and 621 provided at the outer edge portion of the diaphragm 54 and wires 613 and 623 connected to both the end portions of the piezo-resistance sections 611 and 621. On the other hand, the piezo-resistance elements 63 and 64 include a pair of piezo-resistance sections 631 and 641 provided at the outer edge portion of the diaphragm 54, connecting sections 632 and 642 that connect the pair of piezo-resistance sections 631 and 641, and wires 633 and 643 coupled to the other end portions of the pair of piezo-resistance sections 631 and 641.

The piezo-resistance sections 611, 621, 631, and 641 are respectively configured by, for example, doping (diffusing or injecting) impurities such as phosphorus or boron in the first Si layer 511 of the semiconductor substrate 51. The wires 613, 623, 633, and 643 and the connecting sections 632 and 642 are respectively configured by, for example, doping (diffusing or injecting) impurities such as phosphorus or boron in the first Si layer 511 at concentration higher than concentration in the piezo-resistance sections 611, 621, 631, and 641.

The piezo-resistance elements 61, 62, 63, and 64 are configured such that resistance values thereof in a natural state are equal to one another. The piezo-resistance elements 61, 62, 63, and 64 are electrically connected to one another via the wires 613, 623, 633, and 643 or the like to configure a bridge circuit 60 (a Wheatstone bridge circuit) as shown in FIG. 5 and connected to the semiconductor circuit. A driving circuit (not shown in the figure) that supplies a driving voltage AVDC is connected to the bridge circuit 60. The bridge circuit 60 outputs a signal (a voltage) corresponding to the resistance value of the piezo-resistance elements 61, 62, 63, and 64.

The element peripheral structure 7 is formed to define the hollow section 8. The element peripheral structure 7 includes, as shown in FIG. 3, an interlayer insulating film 71, a wiring layer 72 formed on the interlayer insulating film 71, an interlayer insulating film 73 formed on the wiring layer 72 and the interlayer insulating film 71, a wiring layer 74 formed on the interlayer insulating film 73, a surface protection film 75 formed on the wiring layer 74 and the interlayer insulating film 73, and a sealing layer 76. The wiring layer 74 includes a coating layer 741 including a plurality of thin holes 742 that allow the inside and the outside of the hollow section 8 to communicate. The sealing layer 76 disposed on the coating layer 741 seals the thin holes 742. Note that the wiring layers 72 and 74 include wiring layers formed to surround the hollow section 8 and wiring layers configuring wires of the semiconductor circuit. The semiconductor circuit is drawn out to the upper surface of the pressure sensor 3 by the wiring layers 72 and 74. A part of the wiring layer 74 is formed as the connection terminals 743. The connection terminals 743 are electrically connected to the terminals 241a via the bonding wires 15.

The interlayer insulating films 71 and 73 are not particularly limited. However, an insulating film such as a silicon oxide film (SiO₂ film) can be used. The wiring layers 72 and 74 are not particularly limited. However, a metal film such as an aluminum film can be used. The sealing layer 76 is not particularly limited. However, a metal film of Al, Cu, W, Ti, TiN, or the like can be used. The surface protection film 75 is not particularly limited. However, a film having resistance for protecting an element from moisture, dust, scratches, and the like such as a silicon oxide film, a silicon nitride film, a polyimide film, or an epoxy resin film can be used.

The hollow section 8 defined by the substrate 5 and the element peripheral structure 7 is a closed space and functions as a pressure reference chamber having a reference value of pressure detected by the pressure sensor 3. The hollow section 8 is located on the opposite side of the pressure receiving surface 541 of the diaphragm 54 and is disposed to overlap the diaphragm 54. The diaphragm 54 configures a part of a wall section that defines the hollow section 8. The hollow section 8 is in a vacuum state (e.g., 10 Pa or less). Consequently, the pressure sensor 3 can be used as a so-called “absolute pressure sensor element” that detects pressure with reference to the vacuum state. However, the hollow section 8 does not have to be in the vacuum state. For example, the hollow section 8 may be in an atmospheric pressure state, may be in a decompressed state in which air pressure is lower than the atmospheric pressure, or may be a pressurized state in which air pressure is higher than the atmospheric pressure.

### IC Chip

As shown in FIGS. 1 and 2, a semiconductor circuit 41 is provided in the IC chip 4. The semiconductor circuit 41 includes, for example, the temperature sensor 411 for detecting the temperature of the pressure sensor 3 (in particular, the piezo-resistance elements 61 to 64 on the diaphragm 54). Besides, the semiconductor circuit 41 includes an active element such as a MOS transistor and circuit elements such as a capacitor, an inductor, a resistor, a diode, and a wire according to necessity. The semiconductor circuit 41 is electrically connected to the flying leads 241b and 245b via the connection terminals 42 disposed on the upper surface (the surface on the pressure sensor 3 side) of the semiconductor circuit 41.

The semiconductor circuit 41 in the IC chip 4 and the semiconductor circuit in the pressure sensor 3 include, for example, a driving circuit for supplying a voltage to the bridge circuit 60, a temperature compensation circuit for performing temperature compensation of an output from the bridge circuit 60 on the basis of temperature detected by the temperature sensor 411, and an output circuit that converts an output from the temperature compensation circuit into a predetermined output form (CMOS, LV-PECL, LVDS, or the like) and outputs the output. Note that the disposition of the driving circuit, the temperature compensation circuit, the output circuit, and the like is not particularly limited. For example, the driving circuit maybe formed in the semiconductor circuit in the pressure sensor 3 and the temperature compensation circuit and the output circuit may be formed in the semiconductor circuit 41 in the IC chip 4.

The temperature sensor 411 includes piezo-resistance elements (temperature sensor elements) 411a. The piezo-resistance elements 411a have a characteristic that a resistance value changes according to temperature. Therefore, the temperature sensor 411 can detect an ambient temperature (i.e., the temperature of the piezo-resistance elements 61 to 64 on the diaphragm 54) on the basis of a change in a resistance value of the piezo-resistance elements 411a.

The disposition of the piezo-resistance elements 411a is not particularly limited. However, as shown in FIG. 1, at least a part of the piezo-resistance elements 411a are preferably disposed to overlap the diaphragm 54 in plan view. Consequently, it is possible to bring the piezo-resistance elements 411a closer to the diaphragm 54 and more accurately perform the temperature detection of the pressure sensor 3 by the temperature sensor 411. Note that the configuration of the temperature sensor 411 is not limited to this embodiment as long as the temperature sensor 411 can detect the temperature of the pressure sensor 3.

The pressure sensor 3 and the IC chip 4 are explained above. The pressure sensor 3 is joined to the terminals 241a of the wiring sections 241 via the bonding wires 15. Consequently, the pressure sensor 3 is supported by the frame section 231 and the connection terminals 743 are electrically connected to the wiring sections 241. The pressure sensor 3 is disposed with the pressure receiving surface 541 of the diaphragm 54 directed to the lower side (the opposite side of the opening of the package 2). On the other hand, the IC chip 4 is joined to the wiring sections 241 and 245 via the fixing members 14 having electric conductivity. Consequently, the IC chip 4 is supported by the frame section 231 and the connection terminals 42 are electrically connected to the wiring sections 241 and 245. Consequently, the pressure sensor 3 and the IC chip 4 are electrically connected via the wiring sections 241. An electric signal can be output from the IC chip 4 to the outside by the wiring sections 245. The fixing members 14 are not particularly limited as long as the fixing members 14 have electric conductivity. For example, a metal brazing material such as solder, a metal bump such as a gold bump, and a conductive adhesive can be used.

As shown in FIG. 1, the pressure sensor 3 and the IC chip 4 fixed in this way are set in a lifted state (a state of noncontact with the inner wall) in the internal space 28 of the package 2 by the bonding wires 15, the flying leads 241b and 245b, and the filling material 11. Consequently, vibration and the like are less easily transmitted to the pressure sensor 3 and the IC chip 4 via the package 2. Therefore, it is possible to suppress deterioration in pressure detection accuracy by the pressure sensor apparatus 1. In this embodiment, at least a part of the IC chip 4 is disposed to overlap (disposed to vertically overlap) the pressure sensor 3 in plan view. Therefore, lateral spread of the pressure sensor apparatus 1 is suppressed. It is possible to attain a reduction in the size of the pressure sensor apparatus 1.

As shown in FIG. 1, the pressure sensor 3 is disposed with the pressure receiving surface 541 of the diaphragm 54 directed to the lower side. The IC chip 4 is disposed on the lower side of the pressure sensor 3, that is, the pressure receiving surface 541 side. By providing the IC chip 4 on the pressure receiving surface 541 side (to be opposed to the pressure receiving surface 541), it is possible to more accurately detect, with the temperature sensor 411, the temperature of the piezo-resistance elements 61 to 64 on the diaphragm 54. Specifically, if the IC chip 4 is disposed on the opposite side of the side in this embodiment (i.e., the opposite side of the pressure receiving surface 541), the hollow section 8 is interposed between the temperature sensor 411 and the piezo-resistance elements 61 to 64. Since the hollow section 8 is in the vacuum state as explained above, a heat transfer rate is extremely low. Therefore, the temperature of the piezo-resistance elements 61 to 64 is less easily transmitted to the temperature sensor 411. The temperature of the piezo-resistance elements 61 to 64 cannot be accurately detected. On the other hand, in this embodiment, since the hollow section 8 is not interposed between the piezo-resistance elements 61 to 64 and the temperature sensor 411 (the piezo-resistance elements 411a), the heat of the piezo-resistance elements 61 to 64 is efficiently transmitted to the temperature sensor 411. Therefore, according to this embodiment, it is possible to more accurately detect the temperature of the piezo-resistance elements 61 to 64 with the temperature sensor 411.

In particular, in this embodiment, as shown in FIG. 1, since at least a part of the piezo-resistance elements 411a of the temperature sensor 411 are disposed to overlap the diaphragm 54 in plan view, it is possible to further reduce the clearance between the temperature sensor 411 and the piezo-resistance elements 61 to 64. Therefore, the effects explained above are further improved.

### Filling Material

As shown in FIG. 1, the filling material (resin) 11 is filled in the internal space 28 formed in the package 2 to thereby cover the pressure sensor 3 and the IC chip 4 housed in the internal space 28. With the filling material 11, it is possible to protect the pressure sensor 3 and the IC chip 4 (dust proof and waterproof) and reduce external stress acting on the pressure sensor apparatus 1. Note that pressure applied to the pressure sensor apparatus 1 acts on the pressure receiving surface 541 of the pressure sensor 3 via the opening of the housing 22 and the filling material 11.

The filling material 11 only has to be a substance softer than the pressure sensor 3, the IC chip 4, and the package 2. The filling material 11 is, for example, liquid-like or gel-like. As a specific example, silicone oil, fluorine oil, silicone gel, and the like can be used. In other words, the filling material 11 can be a substance having a Young' s modulus smaller than the Young' s modulus of the pressure sensor 3 and the IC chip 4. The viscosity of the filling material 11 is not particularly limited. For example, the penetration of the filling material 11 is preferably in a range of 50 or more and 250 or less and more preferably in a range of 150 or more and 250 or less. Consequently, the filling material 11 can be formed sufficiently soft. The pressure applied to the pressure sensor apparatus 1 efficiently acts on the pressure receiving surface 541.

Note that, in order to more accurately perform the temperature detection by the temperature sensor 411, a heat conductive filler may be dispersed in the filling material 11 (in particular, a portion located between the pressure sensor 3 and the IC chip 4). Consequently, it is possible to improve the thermal conductivity of the filling material 11 and more accurately perform the temperature detection by the temperature sensor 411. As the heat conductive filler, for example, materials having electric conductivity such as metal powder, graphite, and carbon black and materials having insulation such as aluminum nitride, boron nitride, and alumina can be used. Note that, in order to secure the insulation of the filling material 11, as the heat conductive filler, it is preferable to use a material having insulation.

The configuration of the pressure sensor apparatus 1 is explained above.

In the pressure sensor apparatus 1, the diaphragm 54 is flexurally deformed according to pressure received by the pressure receiving surface 541 of the diaphragm 54. Consequently, the piezo-resistance elements 61, 62, 63, and are distorted and the resistance value of the piezo-resistance elements 61, 62, 63, and 64 changes according to a deflection amount thereof. According to the change in the resistance value, an output of the bridge circuit 60 changes. The piezo-resistance elements 61, 62, 63, and 64 have a characteristic that the resistance value thereof changes according to the temperature thereof (environmental temperature) besides the deflection thereof. Therefore, the change in the output of the bridge circuit 60 is caused by the deflection of the piezo-resistance elements 61, 62, 63, and 64 and the temperature of the piezo-resistance elements 61, 62, 63, and 64. Therefore, the semiconductor circuit 41 corrects, on the basis of the temperature of the piezo-resistance elements 61, 62, 63, and 64 detected by the temperature sensor 411, a signal obtained from the bridge circuit 60 and calculates, on the basis of the signal after the correction, the magnitude of the pressure received on the pressure receiving surface 541 and outputs information concerning the magnitude of the pressure.

### Second Embodiment

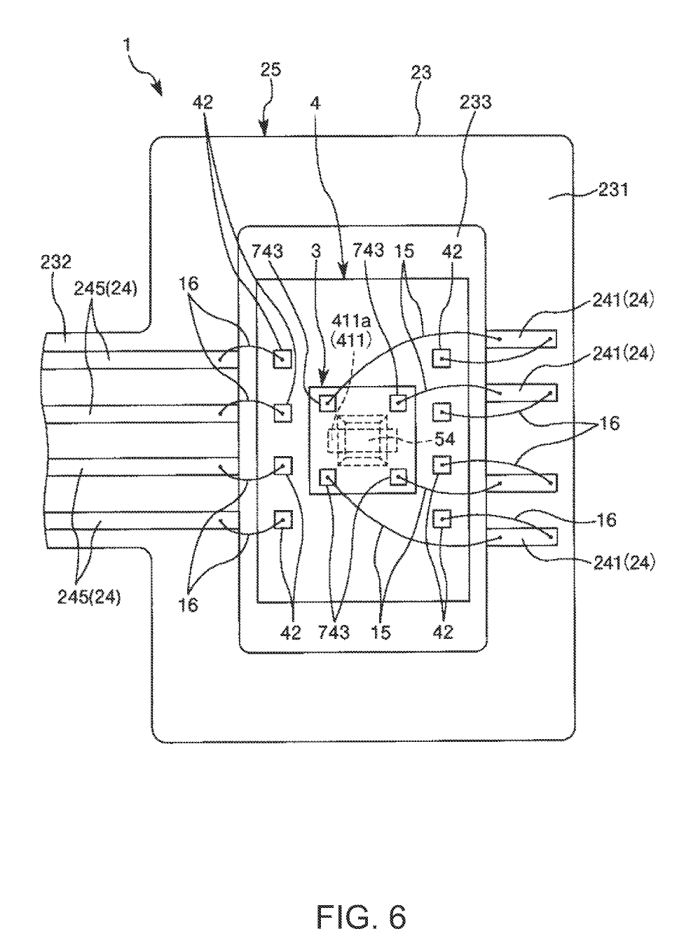

FIG. 6 is a plan view showing a physical quantity sensor apparatus according to a second embodiment of the invention.

The physical quantity sensor apparatus according to the second embodiment is explained below. Differences from the first embodiment are mainly explained. Explanation of similarities is omitted.

The second embodiment is the same as the first embodiment except that the disposition and a connection method of a pressure sensor and an IC chip are different.

As shown in FIG. 6, in the pressure sensor apparatus 1 in this embodiment, both the ends of the wiring sections 241 are located on the frame section 231. That is, unlike the first embodiment, one ends of the wiring sections 241 are not formed as flying leads. The entire pressure sensor 3 is disposed to overlap the IC chip 4 in plan view. In other words, the entire pressure sensor 3 is included in the IC chip 4 in plan view. The IC chip 4 is connected to the wiring sections 241 and 245 via bonding wires (metal wires) 16 and supported. Since the entire pressure sensor 3 overlaps the IC chip 4, compared with the first embodiment, the pressure sensor apparatus 1 having such a configuration can be reduced in size.

According to the second embodiment, it is possible to exhibit effects same as the effects in the first embodiment.

### 2. Altimeter

An example of an altimeter including a physical quantity sensor according to the invention is explained.

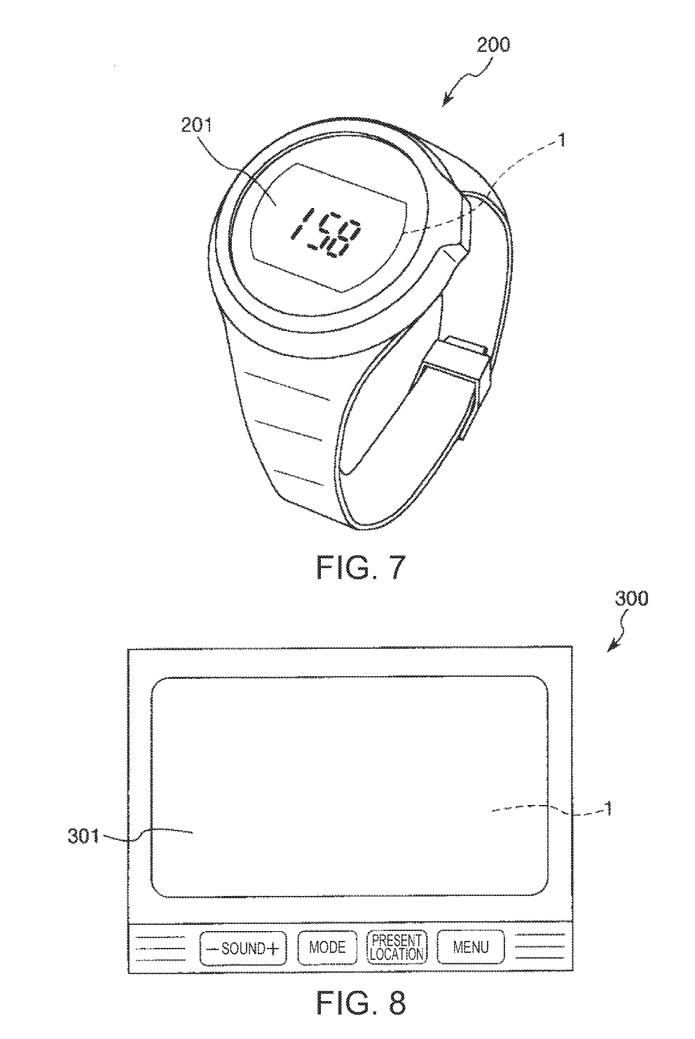

FIG. 7 is a perspective view showing an example of the altimeter according to the invention.

As shown in FIG. 7, an altimeter 200 can be worn on a wrist like a wristwatch. The pressure sensor apparatus 1 is mounted on the inside of the altimeter 200. The altitude above the sea level of the present location, the atmospheric pressure of the present location, and the like can be displayed on a display section 201.

Note that various kinds of information such as the present time, the heart rate of a user, and weather can be displayed on the display section 201.

### 3. Electronic Apparatus

A navigation system to which an electronic apparatus including the physical quantity sensor according to the invention is applied is explained.

FIG. 8 is a front view showing an example of the electronic apparatus according to the invention.

As shown in FIG. 8, a navigation system 300 includes not-shown map information, position information acquiring means from a GPS (Global Positioning System), self-contained navigation means by a gyro sensor, an acceleration sensor, and vehicle speed data, the pressure sensor apparatus 1, and a display section 301 that displays predetermined position information or course information.

With the navigation system 300, it is possible to acquire altitude information in addition to acquired position information. For example, in traveling on an elevated road indicating substantially the same position as a general road on the position information, if the altitude information is not acquired, the navigation system cannot determine whether a vehicle is traveling on the general road or the elevated road. The navigation system provides a user with information concerning the general road as preferential information. Therefore, the navigation system 300 can acquire the altitude information with the pressure sensor apparatus 1, detect an altitude change due to entrance into the elevated road from the general road, and provide the user with navigation information in a traveling state on the elevated road.

Note that the display section 301 is a section that can be reduced in size and thickness such as a liquid crystal display panel or an organic electro-luminescence display.

Note that the electronic apparatus including the physical quantity sensor apparatus according to the invention is not limited to the electronic apparatuses explained above. The electronic apparatus can be applied to, for example, a personal computer, a cellular phone, medical apparatuses (e.g., an electronic thermometer, a sphygmomanometer, a blood sugar level meter, an electrocardiographic apparatus, an ultrasonic diagnostic apparatus, and an electronic endoscope), various measurement apparatuses, meters (e.g., meters of a vehicle, an airplane, and a ship), and a flight simulator.

### 4. Moving Object

A moving object including the physical quantity sensor apparatus according to the invention is explained.

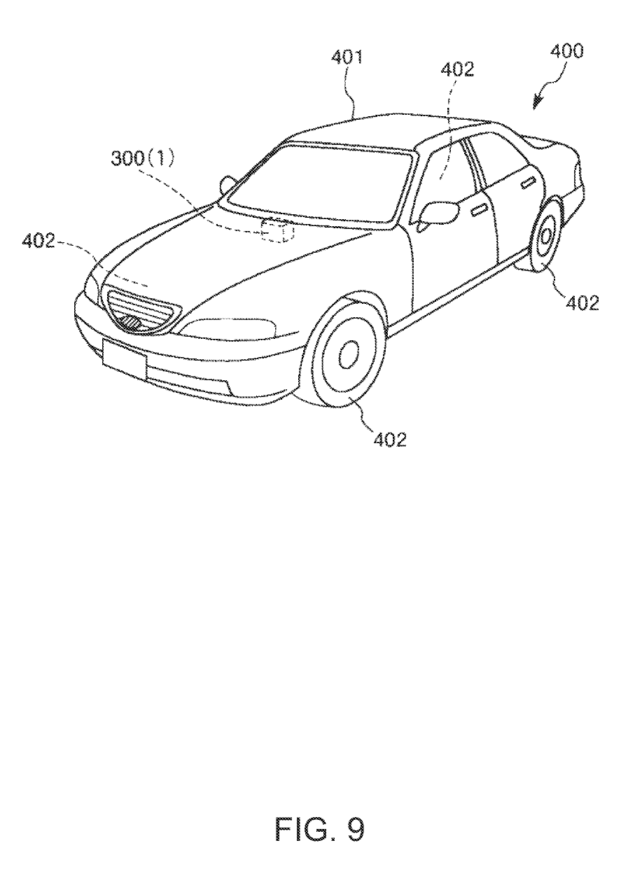

FIG. 9 is a perspective view showing an example of the moving object according to the invention.

As shown in FIG. 9, a moving object 400 includes a vehicle body 401 and four wheels 402 and is configured to rotate the wheels 402 with a not-shown power source (engine) provided in the vehicle body 401. The navigation system 300 (the pressure sensor apparatus 1) is incorporated in the moving object 400.

The physical quantity sensor apparatus, the altimeter, the electronic apparatus, and the moving object according to the invention are explained above with reference to the embodiments shown in the figures. However, the invention is not limited to these apparatuses. The components of the sections can be replaced with any components having similar functions. Any other components and processes may be added. The embodiments may be combined as appropriate.

In the embodiments, the pressure sensor section including the piezo-resistance element is explained as the pressure sensor section included in the pressure sensor. However, the pressure sensor section is not limited to this pressure sensor section. For example, a pressure sensor section including a flat-type oscillator, other MEMS oscillators such as a comb-teeth electrode, and a vibrating element such as a quartz oscillator can also be used.

What is claimed is:

1. A physical quantity sensor apparatus comprising:
a physical quantity sensor including a flexurally deformable diaphragm including a pressure receiving surface; and
a temperature sensor element disposed on the pressure receiving surface side of the diaphragm to be spaced apart from the diaphragm.

2. The physical quantity sensor apparatus according to claim 1, wherein the temperature sensor element at least partially overlaps the diaphragm in plan view of the pressure receiving surface.

3. The physical quantity sensor apparatus according to claim 1, wherein the physical quantity sensor includes a pressure reference chamber on a surface side opposite to the pressure receiving surface of the diaphragm.

4. The physical quantity sensor apparatus according to claim 1, wherein the physical quantity sensor includes a signal output section configured to output a signal corresponding to deflection of the diaphragm.

5. The physical quantity sensor apparatus according to claim 4, wherein the signal output section includes a piezo-resistance element disposed in the diaphragm.

6. The physical quantity sensor apparatus according to claim 1, wherein the physical quantity sensor apparatus includes resin disposed between the diaphragm and the temperature sensor element.

7. The physical quantity sensor apparatus according to claim 6, wherein the resin is gel-like or liquid-like.

8. An altimeter comprising the physical quantity sensor apparatus according to claim 1.

9. An electronic apparatus comprising the physical quantity sensor apparatus according to claim 1.

10. A moving object comprising the physical quantity sensor apparatus according to claim 1.
